(19) United States
(12) Patent Application Publication
(10) Pub. No.: US 2017/0028648 A1
(43) Pub. Date: Feb. 2, 2017

(54) 3D DATA GENERATION APPARATUS AND METHOD, AND STORAGE MEDIUM

(71) Applicant: CANON KABUSHIKI KAISHA, Tokyo (JP)

(72) Inventor: Motoyuki ASANO, Tokyo (JP)

(21) Appl. No.: 15/215,645

(22) Filed: Jul. 21, 2016

(30) Foreign Application Priority Data
Jul. 27, 2015 (JP) 2015-148032

(51) Int. Cl. B29C 67/00; B33Y 50/02; G06F 17/50; G06T 7/00

(52) U.S. Cl. CPC B29C 67/0088; G06T 7/0065; B33Y 50/02; G06F 17/50; G06T 2207/10004; G05B 2219/35006

(57) ABSTRACT

A 3D data generation apparatus includes: an acquisition unit that acquires a plurality of images and distance information that corresponds to distances in a depth direction to an object in the plurality of images; a determination unit that determines a layout for presenting the plurality of images as a piece of 3D data; and a combining unit that combines the plurality of images in accordance with the layout determined by the determination unit. The determination unit converts, for distance information of each image in the 3D data, the distance information of each of the plurality of images based on a predetermined criterion.

### BACKGROUND OF THE INVENTION

Field of the Invention

The present invention relates to an apparatus that generates 3D index print data from still images.

Description of the Related Art

There are conventionally known techniques to acquire 3D shape data by scanning the shape of a real substance. Examples of such techniques include a method of acquiring 3D shape data of a substance by calculating distance information of measurement points of a target substance using reflected laser light, and a method of calculating 3D shape data of a substance from disparity image data acquired from a plurality of image capturing units that are arranged to have disparity. Another example of such techniques is a method of generating 3D shape data by acquiring distance information from pixel areas of a captured image using a special image sensor, such as an image plane phase difference sensor. For example, Japanese Patent Laid-Open No. 2004-037396 discloses a method of effectively acquiring 3D shape data from a real substance using a combination of laser ranging and the result of image capture.

Not only the industrial fields but also general households are increasingly using 3D printers that produce 3D shape substances using a formation method in which a resin or metallic material is melted and layered based on 3D shape data of 3D CAD and the like, or a formation method in which laser light is applied to a material that cures when exposed to light. For example, Japanese Patent Laid-Open No. 2001-301267 discloses a method of forming any 3D substance by performing layer printing using curable ink.

Many index printing methods have been proposed for the purpose of management and viewing of a list of images; in index printing, all of a plurality of captured images, or representative images among them, are laid out in a vertical direction, a horizontal direction, or another direction in one image, and the images thus laid out are printed on printing paper or a similar printing medium. Japanese Patent No. 3104940 discloses a method of generating and printing one combined image corresponding to the number of captured frames.

However, the aforementioned patent documents do not suggest 3D index printing in which a plurality of pieces of image data are arranged in an index layout and printed in 3D.

### SUMMARY OF THE INVENTION

The present invention has been made in view of the above issue, and provides a 3D data generation apparatus that enables 3D index printing of a plurality of images with distance information that are arranged in an index layout in one image.

According to a first aspect of the present invention, there is provided a 3D data generation apparatus, comprising: an acquisition unit that acquires a plurality of images and distance information that corresponds to distances in a depth direction to an object in the plurality of images; a determination unit that determines a layout for presenting the plurality of images as a piece of 3D data; and a combining unit that combines the plurality of images in accordance with the layout determined by the determination unit, wherein the determination unit converts, for distance information of each image in the 3D data, the distance information of each of the plurality of images based on a predetermined criterion.

According to a second aspect of the present invention, there is provided a 3D data generation apparatus, comprising: an extraction unit that extracts a plurality of object regions including a specific object from a plurality of images that have distance information corresponding to distances in a depth direction to one or more objects; a determination unit that determines a layout for presenting, as a piece of 3D data, images of the plurality of object regions extracted by the extraction unit; and a combining unit that combines the images of the plurality of object regions in accordance with the layout determined by the determination unit, wherein the determination unit converts, for distance information of each image in the 3D data, the distance information of an image of each of the plurality of object regions based on a predetermined criterion.

According to a third aspect of the present invention, there is provided a 3D data generation method, comprising: acquiring a plurality of images and distance information that corresponds to distances in a depth direction to an object in the plurality of images; determining a layout for presenting the plurality of images as a piece of 3D data; and combining the plurality of images in accordance with the determined layout, wherein in the determination, for distance information of each image in the 3D data, the distance information of each of the plurality of images is converted based on a predetermined criterion.

According to a fourth aspect of the present invention, there is provided a 3D data generation method, comprising: extracting a plurality of object regions including a specific object from a plurality of images that have distance information corresponding to distances in a depth direction to one or more objects; determining a layout for presenting, as a piece of 3D data, images of the plurality of object regions extracted; and combining the images of the plurality of object regions in accordance with the determined layout, wherein in the determination, for distance information of each image in the 3D data, the distance information of an image of each of the plurality of object regions is converted based on a predetermined criterion.

Further features of the present invention will become apparent from the following description of exemplary embodiments with reference to the attached drawings.

### BRIEF DESCRIPTION OF THE DRAWINGS

FIG. 1 is a block diagram showing an internal configuration of an image capturing apparatus according to embodiments of the present invention.

FIG. 2 is a diagram for explaining the configurations of an image sensor and a microlens array.

FIG. 3 is a diagram for explaining the configurations of an image capturing lens, the microlens array, and the image sensor.

FIGS. 4A and 4B are diagrams for explaining correspondence between pupil regions of the image capturing lens and light-receiving pixels.

FIG. 5 is a flowchart of processing for generating 3D print data in a first embodiment.

FIG. 6 shows an example of a substance formed by 3D printing in the first embodiment.

FIG. 7 shows an example of an image displayed for layout selection in the first embodiment.

FIG. 8 shows the distances to objects in images in the first embodiment.

FIG. 9 is a flowchart of processing for generating 3D print data in a second embodiment.

FIG. 10 shows an example of a substance formed by 3D printing in the second embodiment.

FIG. 11 shows an example of an image displayed for designation of a specific object in the second embodiment.

FIG. 12 is a diagram for explaining a method of extracting the specific object in the second embodiment.

FIG. 13 shows an example of an image displayed for layout selection in the second embodiment.

FIG. 14 shows the distances to the object and the sizes of the object in the second embodiment.

### DESCRIPTION OF THE EMBODIMENTS

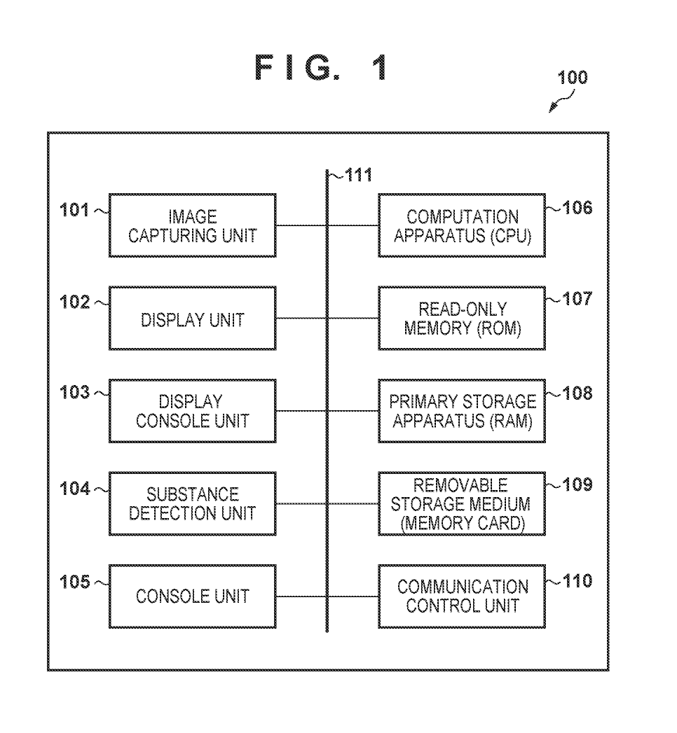

The following describes embodiments of the present invention in detail, with reference to the attached drawings. First, a description is given of configurations that are shared in common among the embodiments of the present invention. FIG. 1 is a block diagram showing an example of a configuration of an image capturing apparatus 100 serving as an embodiment of a 3D data generation apparatus according to the present invention.

In FIG. 1, an image capturing unit 101 may be composed of a plurality of optical systems and a plurality of image sensors corresponding thereto, or may be composed of one optical system and one image sensor corresponding thereto. For example, when the image capturing unit 101 is composed of two optical systems and two image sensors corresponding thereto, 3D shape data can be calculated from disparity information acquired from two viewpoints. On the other hand, when the image capturing unit 101 is composed of one optical system and one image sensor corresponding thereto, the image sensor is configured to acquire object distance information on a pixel-by-pixel basis, and generation of 2D image data and calculation of 3D shape data can be performed simultaneously.

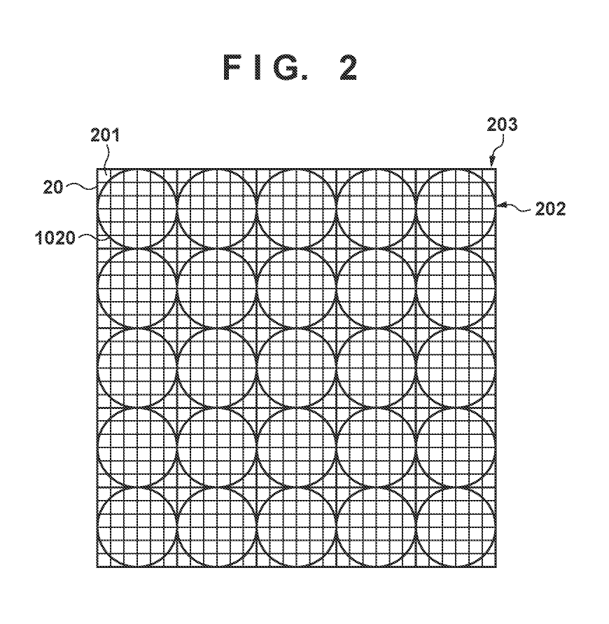

A description is now given of an example case in which the image capturing unit 101 is composed of one optical system and one image sensor corresponding thereto, and is capable of acquiring object distance information. FIG. 2 shows an image sensor 203 used in the image capturing unit 101 and a microlens array 202 disposed in front of the image sensor 203, as observed in the direction of an optical axis of an image capturing optical system. One microlens 1020 is disposed in correspondence with a plurality of photoelectric conversion units 201.

A plurality of photoelectric conversion units 201 behind one microlens are collectively defined as a unit pixel 20. In the present embodiment, it will be assumed that each unit pixel 20 includes a total of twenty-five photoelectric conversion units 201 arranged in five rows and five columns, and the image sensor 203 includes twenty-five unit pixels 20 arranged in five rows and five columns.

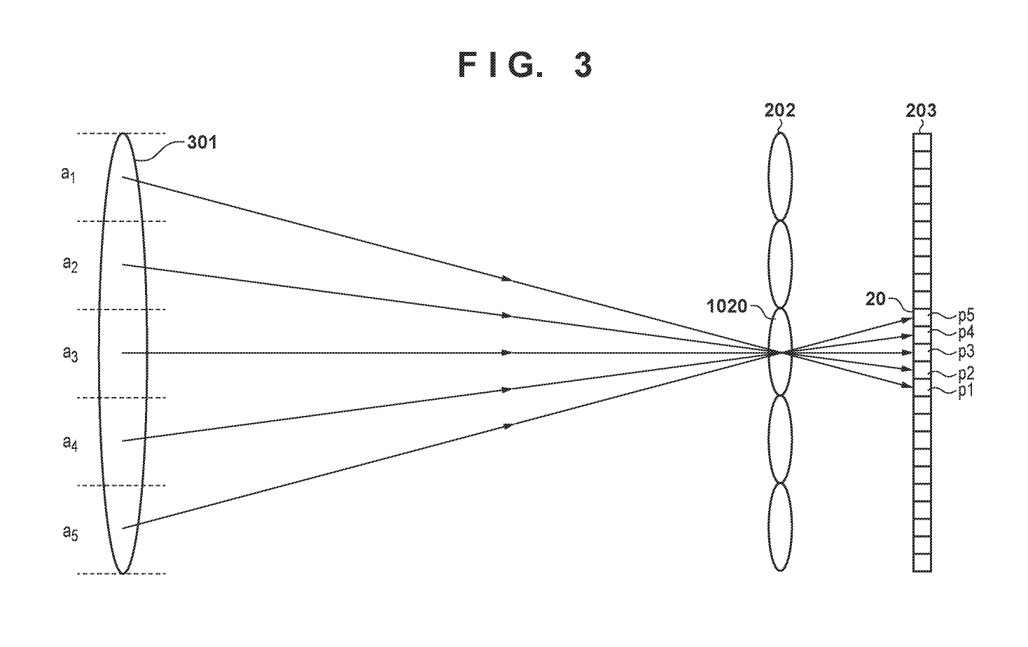

FIG. 3 shows how light emitted from an image capturing optical system 301 passes through one microlens 1020 and is received by the image sensor 203, as observed in the direction perpendicular to the optical axis. Beams of light that have been emitted from pupil regions a1 to a5 of the image capturing optical system 301 and passed through the microlens 1020 form images on corresponding photoelectric conversion units p1 to p5 behind the microlens 1020.

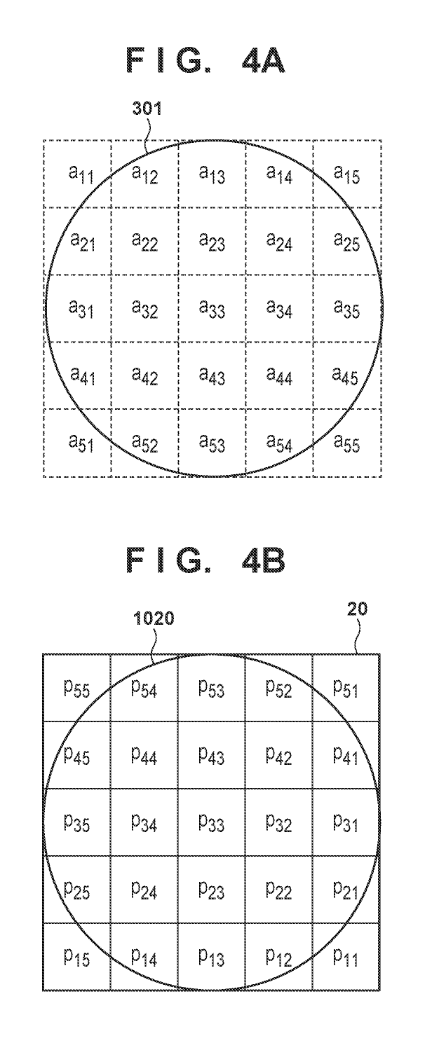

FIG. 4A shows an aperture of the image capturing optical system 301 as viewed in the direction of the optical axis. FIG. 4B shows one microlens 1020 and a unit pixel 20 therebehind as viewed in the direction of the optical axis. In FIG. 4A, a pupil region of the image capturing optical system 301 is divided into regions that are equal in number to the photoelectric conversion units behind one microlens; in this case, light emitted from one pupil division region of the image capturing optical system 301 forms an image on one photoelectric conversion unit. It will be assumed here that the f-number of the image capturing optical system 301 is substantially the same as the f-number of the microlenses 1020.

When viewed in the direction of the optical axis, pupil division regions a11 to a55 of the image capturing optical system 301 shown in FIG. 4A and photoelectric conversion units p11 to p55 shown in FIG. 4B exhibit point symmetry. That is to say, light emitted from the pupil division region a11 of the image capturing optical system 301 forms an image on the photoelectric conversion unit p11 included in the unit pixel 20 behind a microlens. Similarly, light that has been emitted from the pupil division region a11 and passed through another microlens 1020 forms an image on the photoelectric conversion unit p11 included in the unit pixel 20 behind that microlens.

A description is now given of a method of calculating a focus position corresponding to a freely-selected object position within a screen (within an image). As described with reference to FIGS. 4A and 4B, different photoelectric conversion units of the unit pixels 20 receive beams of light that have passed through different pupil regions of the image capturing optical system 301. Based on resultant divided signals, signals of a plurality of photoelectric conversion units are combined; as a result, a pair of signals corresponding to horizontal pupil division is generated.

Σₐ₌₁⁵Σ_{b=1}²(pab) (Expression 1)

Σₐ₌₁⁵Σ_{b=4}⁵(pab) (Expression 2)

Expression 1 integrates beams of light that have passed through left-side regions (pupil regions a11 to a51, a12 to a52) of an exit pupil of an image capturing lens 101 and have been received by corresponding photoelectric conversion units of a certain unit pixel 20. This is applied to a plurality of unit pixels 20 lined up in the horizontal direction, and an object image composed of a group of resultant output signals is used as an A image. Expression 2 integrates beams of light that have passed through right-side regions (pupil regions a14 to a54, a15 to a55) of the exit pupil of the image capturing lens 101 and have been received by corresponding photoelectric conversion units of a certain unit pixel 20. This is applied to a plurality of unit pixels 20 lined up in the horizontal direction, and an object image composed of a group of resultant output signals is used as a B image. Correlation computation is performed with respect to the A image and the B image to detect an image shift amount (a pupil division phase difference). Furthermore, a focus position corresponding to a freely-selected object position within the screen can be calculated by multiplying the image shift amount by a conversion coefficient defined by a focus position of the image capturing lens 101 and the optical system. In addition, an object distance can be calculated from the calculated focus position. Although the A image and the B image are respectively acquired by integrating signals of left-side regions and signals of right-side regions of a plurality of unit pixels 20 in the foregoing description, a similar effect is achieved by using signals of the plurality of unit pixels 20 individually without performing the integration with respect to the plurality of unit pixels 20. Furthermore, with the foregoing configuration, an object distance map and a defocus amount map can be calculated for the entire screen, and distance information of an object is information corresponding to a distance to the object in the depth direction including information of such maps. Object distance information on an image capturing screen can be acquired in the above-described manner.

Returning to the description of FIG. 1, a display unit 102 is constituted by an LCD or a similar display, and can perform through-the-lens display of images from the image capturing unit 101, and display captured images, information of the captured images, and the like. A display console unit 103 is composed of, for example, a touchscreen disposed on the display unit 102, detects a touch made by a user's finger and the like, and transmits information of the detection to a CPU 106 via a bus 111 as operational information. A substance detection unit 104 applies substance detection processing to image data acquired by the image capturing unit 101. Substance detection processing is processing for detecting a person, a substance, and the like within an image, calculating such data as their positions and sizes, and transmitting the calculated data to the CPU 106. A console unit 105 accepts an instruction from a user via, for example, a console button.

A computation apparatus (CPU) 106 controls the overall operations of the image capturing apparatus 100. A control program for the image capturing apparatus 100, information necessary for control, and the like are prestored in a read-only memory (ROM) 107, and the CPU 106 controls the image capturing apparatus 100 based on the control program and the like stored in the ROM 107. A primary storage apparatus (RAM) 108 can temporarily hold various types of data during the operations of the image capturing apparatus 100. Data held in the RAM 108, such as image information, can be recorded/stored to a removable recording medium (memory card) 109 via the bus 111.

A communication control unit 110 establishes wireless or wired connection to an external apparatus, and transmits/receives video signals and audio signals. The communication control unit 110 can also establish connection to a wireless LAN and the Internet. The communication control unit 110 can transmit image data of images captured by the image capturing unit 101 and image data stored in the memory card 109, and receive image data and various types of information from an external apparatus.

The embodiments of the present invention will now be described.

### FIRST EMBODIMENT

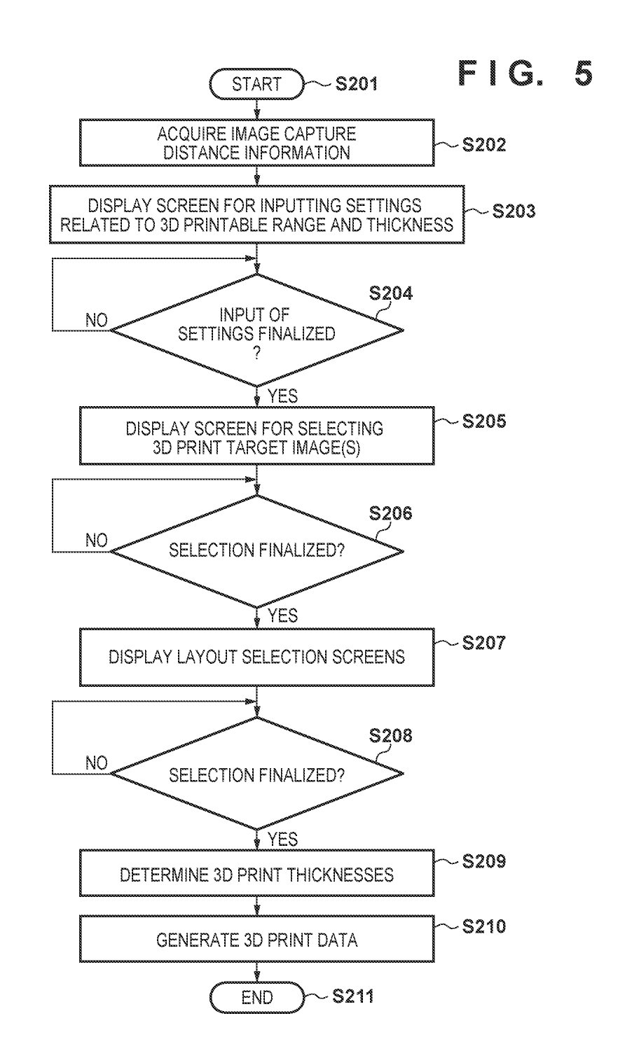

The following describes a method of generating 3D print data in a first embodiment of the present invention, in which a plurality of images having distance information acquired by the image capturing unit 101 are laid out in a single image and combined, and the thickness is determined based on the distance information of each image. FIG. 5 is a flowchart of processing for generating 3D print data in the present embodiment.

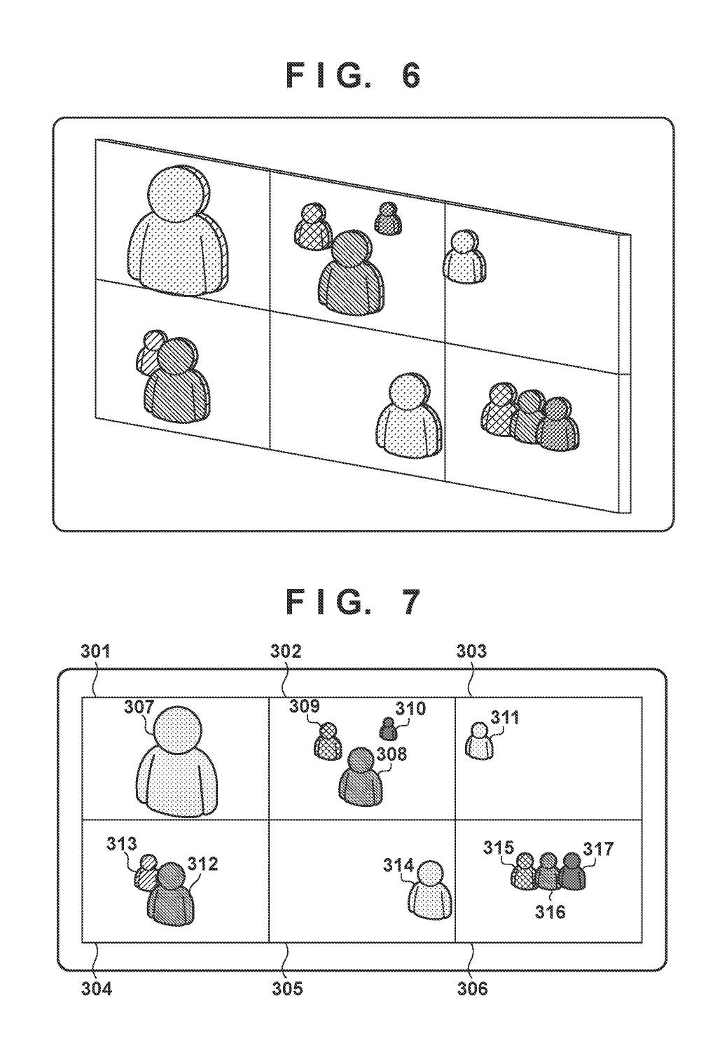

It will be assumed that a 3D printout of the present embodiment is in relief. For example, as shown in FIG. 6, six captured images are arranged in an index layout with three columns and two rows, and the images are presented in relief through 3D printing.

Processing starts with step S201. It will be assumed that, at this time, the power of the image capturing apparatus 100 is already ON. Next, in step S202, the image capturing unit 101 captures images of objects, thereby acquiring the images and distance information. This process will now be described.

In the present embodiment, as described with reference to FIGS. 2 to 4B, the image capturing unit 101 has an image plane phase difference detection function, and can acquire distance information on a pixel-by-pixel basis. Therefore, the execution of image capturing processing from a freely-selected position enables acquisition of color data of pixels within an image, as well as distance information of the pixels indicating the distances to surface portions of target substances. This data serves as raw 3D data for acquiring point group data of the pixels indicating the distances in the depth direction. After the image capture, image data including this 3D data is temporarily written to the RAM 108 in response to an instruction from the CPU 106. Thereafter, the CPU 106 reads out the image data from the RAM 108, and writes the image data to the memory card 109 via the bus 111. Similar image capturing processing and processing for acquiring an image and distance information are executed until the necessary number of images with the necessary number of objects is acquired.

Next, in step S203, the CPU 106 instructs the display unit 102, via the bus 111, to perform display so as to cause a user to input printable sizes in the vertical, horizontal, and thickness directions in a 3D printing apparatus to be used, and then proceeds to step S204. In step S204, the CPU 106 judges whether the input of the printable sizes has been finalized via the display console unit 103 or the console unit 105; it proceeds to step S205 if the input has been finalized, and stands by if the input has not been finalized.

In step S205, the CPU 106 loads, to the RAM 108, image data of an allowable memory size that has been written to the memory card 109. Then, the CPU 106 generates a display image that prompts simultaneous selection of one or more images as 3D print target images from the image data loaded to the RAM 108, transmits the display image to the display unit 102, and proceeds to step S206.

In step S206, the CPU 106 judges whether the selection of the 3D print target images has been finalized via the display console unit 103 or the console unit 105; it proceeds to step S207 if the selection has been finalized, and stands by if the selection has not been finalized.

In step S207, the CPU 106 generates layout selection images that prompt a selection of a layout for presenting a piece of 3D print data corresponding to the number of the 3D print target images selected in step S206. FIG. 7 shows an example of an image displayed as a layout selection image; in this example, six images are arranged on one screen, in an index layout with three columns and two rows. Other layout examples include: two columns and three rows; six columns and one row; and one column and six rows. In another layout example, a specific image is used as a main print image and displayed in a large size, and other images are used as sub print images and displayed around the main print image in a size smaller than the size of the main print image. The CPU 106 transmits the layout selection images to the display unit 102, and proceeds to step S208.

In step S208, the CPU 106 judges whether the selection of a layout for presenting the 3D print data has been finalized via the display console unit 103 or the console unit 105; it proceeds to step S209 if the selection has been finalized, and stands by if the selection has not been finalized.

In step S209, based on the determined layout, the CPU 106 converts the vertical and horizontal widths of each image into the actual print widths that fall within a 3D printable range in the vertical and horizontal directions. At this time, the ratio between the vertical width and the horizontal width of each image is maintained in determining the print width conversion rate so that a substance formed by printing does not look strange. Next, distance information indicating the distances to objects in the images is normalized so that print thicknesses are equal to or smaller than a 3D printable thickness, that is to say, based on a predetermined criterion corresponding to a printable thickness in the 3D printer that is scheduled to perform output.

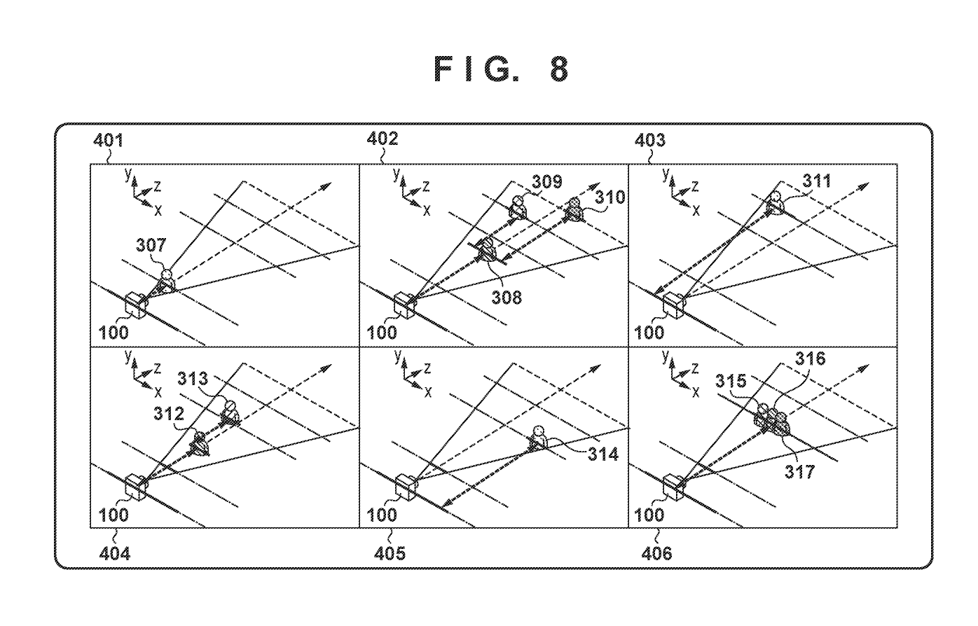

In FIGS. 8, 401 to 406 show the distances between the image capturing apparatus 100 and the objects in the images 301 to 306 shown in FIG. 7. For example, in the case of 402, a range to be printed should be from a position of an object 308 closest to the image capturing apparatus 100, to a boundary portion of an object 310 (an outline portion of the object 310) for which distance information can be acquired, in the direction of the depth as viewed from the image capturing apparatus 100. At this time, the print thicknesses are determined by normalizing the distance information indicating the distance to each object so that the foregoing range is equal to or smaller than the printable thickness. Then, the CPU 106 generates a piece of 3D image data by applying combining processing to all of portions where boundary portions of neighboring images are in contact with each other.

In step S210, the CPU 106 generates 3D print data based on the 3D image data, writes the 3D print data to the memory card 109 via the bus 111, and ends the sequence of processes. This 3D print data is a data file that is described in an STL format, an VRML format, and the like, and is usable on the 3D printing apparatus. A keynote of the present embodiment is the method of generating 3D index print data from a plurality of images with distance information, and thus no restriction is intended regarding a final output file format.

As described above, in the present embodiment, a plurality of images having distance information are laid out in a single image and thereafter are combined, so that 3D index print data which has thicknesses determined based on distance information of each image can be generated.

Furthermore, in the present embodiment, the normalization is performed such that the print thickness of each image is equal to or smaller than the printable thickness based on the distance information of the image. Alternatively, the print thickness of each image may be determined by arranging all objects in absolute distances in which they exist and performing normalization such that all the objects are fit within the printable thickness.

### SECOND EMBODIMENT

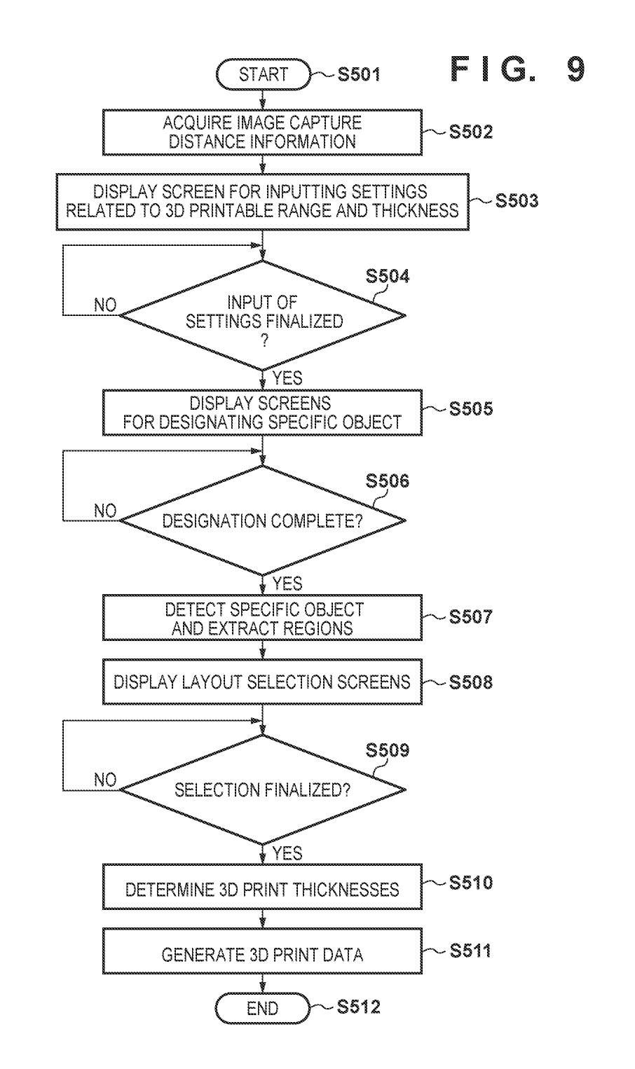

The following describes a method of generating 3D print data, which has thicknesses determined based on the sizes and distance information of a specific object, by extracting images including the specific object from a plurality of images and combining the extracted images laid out in one image in a second embodiment of the present invention. FIG. 9 is a flowchart of processing for generating 3D print data in the present embodiment. It will be assumed that a 3D printout of the present embodiment is in relief. For example, as shown in FIG. 10, three images acquired by extracting regions including a specific object are arranged in three columns, and the images are presented in relief through 3D printing.

In FIG. 9, the processes of steps S501 to S504 are similar to the processes of steps S201 to S204 according to the first embodiment, and thus the explanation thereof will be omitted.

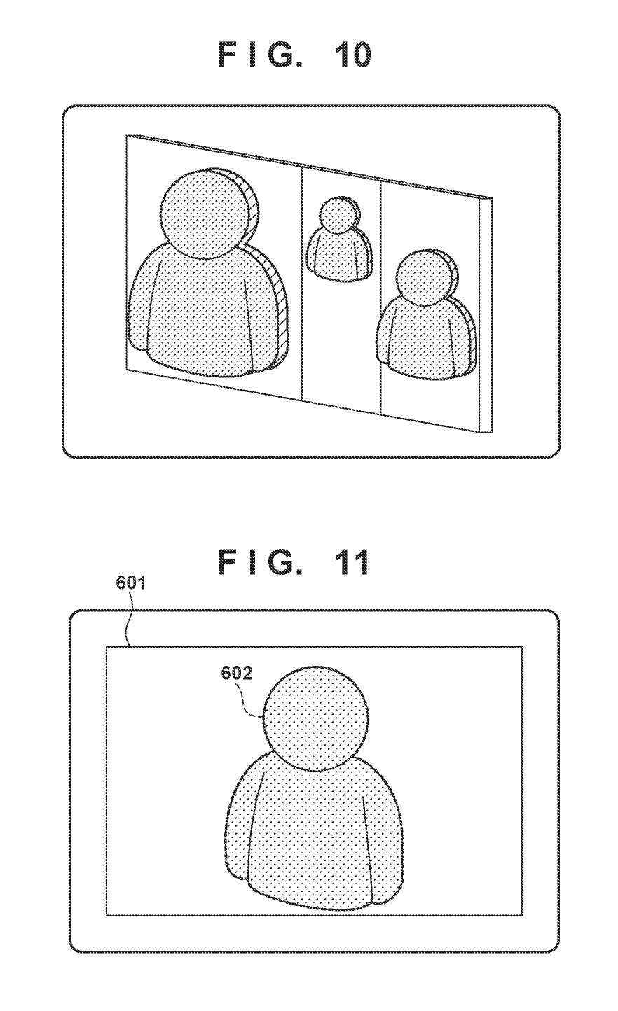

In step S505, the CPU 106 loads, to the RAM 108, image data of an allowable memory size that has been written to the memory card 109. The substance detection unit 104 detects a substance(s) that is present in the image data loaded to the RAM 108 on a data-by-data basis. The CPU 106 generates specific object designation images by superimposing the result of substance detection performed by the substance detection unit 104 over the image data. The CPU 106 transmits the specific object designation images to the display unit 102, and proceeds to step S506. For example, in the case of FIG. 11, the substance detection unit 104 detects an object 602 within an image 601, and an outline portion of the detected object (substance) is indicated by a dash line in a display image. A user operates the display console unit 103 or the console unit 105 to sequentially display the specific object designation images generated from images in the RAM 108. Then, the detected object within the specific object designation images displayed on the display unit 102 is designated. In the present embodiment, the object 602 is designated as a specific object.

In step S506, the CPU 106 judges whether the designation of the specific object extracted from the images has been finalized via the display console unit 103 or the console unit 105; it proceeds to step S507 if the designation has been finalized, and stands by if the designation has not been finalized.

In step S507, the substance detection unit 104 selects image data including the specific object 602 from among a plurality of pieces of captured image data based on the result of the designation of the specific object finalized in step S506, and detects specific object regions within the selected image data. The CPU 106 extracts images including the detected specific object regions from the memory card 109, and writes the extracted images to the RAM 108 via the bus 111.

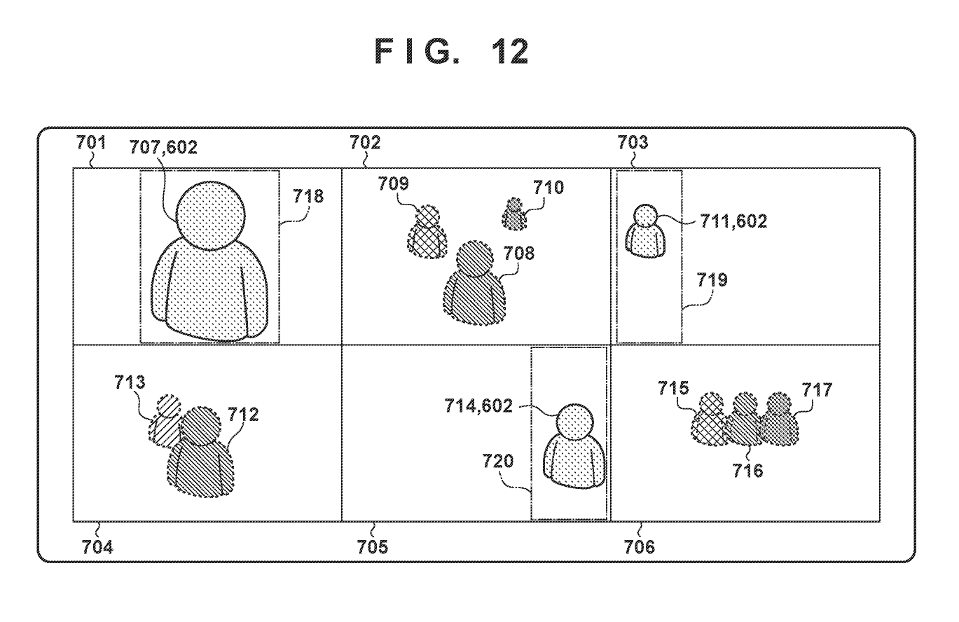

With reference to FIG. 12, a description is now given of a procedure for selecting image data including the specific object, and extracting regions including the specific object. Images 701 to 706 are stored in the memory card 109. The substance detection unit 104 selects images including the specific object 602 from among the images 701 to 706, and detects specific object regions 707, 711, 714 (the specific object regions 707, 711, 714 include the specific object 602). Then, region images including the specific object regions 707, 711, 714 are extracted. In FIG. 12, the region images are extracted as specific object extraction images 718, 719, 720 with a vertical width equal to a vertical width of the original images, and a horizontal width that allows the corresponding specific object region and some extra pixels to fit therewithin. Regarding the extraction method, the outlines of the extracted specific object regions may perfectly match the outlines of the specific object, or the extracted specific object regions may include the foregrounds and backgrounds.

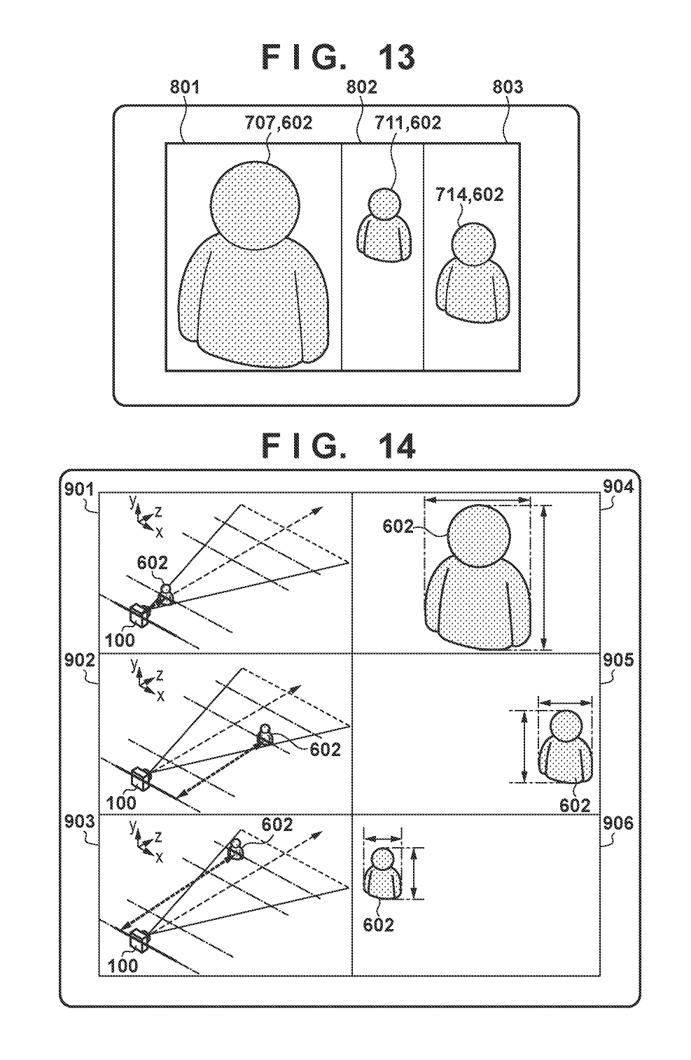

In step S508, the CPU 106 generates layout selection images that prompt a selection of a layout for presenting a piece of 3D print data corresponding to the image data extracted in step S507. FIG. 13 shows an example of an image displayed as a layout selection image; in this example, three extracted images are arranged on one screen, in an index layout with one row. Other layout examples are as follows: the extracted images are arranged in one column; the extracted images are rearranged; and when, for example, the extracted images differ from one another in the vertical and horizontal sizes, the extracted images are arranged in an enlarged or reduced state. The CPU 106 transmits the layout selection images to the display unit 102, and proceeds to step S509.

In step S509, the CPU 106 judges whether the selection of a layout for presenting the 3D print data has been finalized via the display console unit 103 or the console unit 105; it proceeds to step S510 if the selection has been finalized, and stands by if the selection has not been finalized.

In step S510, based on the layout determined in step S509, the CPU 106 converts the vertical and horizontal widths of the images into the actual print widths that fall within a 3D printable range in the vertical and horizontal directions. At this time, the ratio between the vertical width and the horizontal width of each image is maintained in determining the print width conversion rate so that a substance formed by printing does not look strange. Next, based on distance information indicating the distance to the specific object in each image and on the size of the specific object, the print thickness is determined to be equal to or smaller than a 3D printable thickness.

In FIGS. 14, 901 to 903 show the distances between the image capturing apparatus 100 and the specific object 602. Furthermore, in FIGS. 14, 904 to 906 show the sizes of the specific object 602 included in 2D image data. For example, distance information indicating a distance from the image capturing unit 100 to the object 602 in the depth direction can be acquired from 901. On the other hand, 904 includes the percentage of the specific object region in a 2D image, or the maximum numbers of pixels within the specific object region in the vertical and horizontal directions, as information indicating the size of the specific object. The print thicknesses are determined based on these two pieces of information. For example, in the case of 901 and 904, the determined print thickness is large because the specific object 602 is within a short distance and the percentage of the object 602 (707) in the image 701 is large. Conversely, in the case of 903 and 906, the determined print thickness is small because the object 602 is located far from the image capturing apparatus 100 and the percentage of the object 602 (711) in the image 703 is small. Then, the CPU 106 generates a piece of 3D image data by applying combining processing to all of portions where boundary portions of neighboring images are in contact with each other.

In step S511, the CPU 106 generates 3D print data based on the 3D image data, writes the 3D print data to the memory card 109 via the bus 111, and ends the sequence of processes. Similarly to the first embodiment, a keynote of the present embodiment is the method of generating 3D index print data from a plurality of images with distance information, and thus no restriction is intended regarding a final output file format of the 3D print data.

As described above, in the present embodiment, regions including a specific object are extracted from a plurality of images, the extracted images are laid out in one image, and then the extracted images are combined. This makes it possible to generate 3D index print data with thicknesses determined based on distance information and the sizes of the specific object.

Furthermore, in the present embodiment, the normalization is performed based on the distance information and sizes of the specific object such that the print thickness of each image is equal to or smaller than the printable thickness. Alternatively, the print thickness of each image may be determined by arranging the specific object in an absolute distance in which the specific object exists, and performing normalization such that the specific object can fit within the printable thickness.

Although preferred embodiments of the present invention have been described thus far, the present invention is not limited to these embodiments, and various modifications and changes can be made within the scope of the principles of the present invention.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-148032, filed Jul. 27, 2015, which is hereby incorporated by reference herein in its entirety.

What is claimed is:

1. A 3D data generation apparatus, comprising:
an acquisition unit that acquires a plurality of images and distance information that corresponds to distances in a depth direction to an object in the plurality of images;
a determination unit that determines a layout for presenting the plurality of images as a piece of 3D data; and
a combining unit that combines the plurality of images in accordance with the layout determined by the determination unit, wherein
the determination unit converts, for distance information of each image in the 3D data, the distance information of each of the plurality of images based on a predetermined criterion.

2. The 3D data generation apparatus according to claim 1, wherein
the predetermined criterion is a printable thickness in a printing apparatus that performs printing based on the 3D data.

3. The 3D data generation apparatus according to claim 1, wherein
the distance information of each image in the 3D data is information indicating a thickness in the 3D data, and the determination unit converts the distance information of each of the plurality of images into the information indicating the thickness in the 3D data through normalization based on a predetermined distance.

4. The 3D data generation apparatus according to claim 1, wherein
the distance information of each image in the 3D data is information indicating a thickness in the 3D data, and the determination unit determines the thickness in the 3D data in accordance with an absolute distance in which an object in each image exists, based on the distance information of each of the plurality of images.

5. The 3D data generation apparatus according to claim 3, wherein
the determination unit determines the thickness in the 3D data to be equal to or smaller than a printable thickness in a printing apparatus that performs printing based on the 3D data.

6. The 3D data generation apparatus according to claim 1, wherein
the determination unit determines vertical and horizontal widths of each image in the 3D data to fall within a printable range in a printing apparatus that performs printing based on the 3D data.

7. A 3D data generation apparatus, comprising:
an extraction unit that extracts a plurality of object regions including a specific object from a plurality of images that have distance information corresponding to distances in a depth direction to one or more objects;
a determination unit that determines a layout for presenting, as a piece of 3D data, images of the plurality of object regions extracted by the extraction unit; and
a combining unit that combines the images of the plurality of object regions in accordance with the layout determined by the determination unit, wherein the determination unit converts, for distance information of each image in the 3D data, the distance information of an image of each of the plurality of object regions based on a predetermined criterion.

8. The 3D data generation apparatus according to claim 7, wherein
the predetermined criterion is a printable thickness in a printing apparatus that performs printing based on the 3D data.

9. The 3D data generation apparatus according to claim 7, wherein
the distance information of each image in the 3D data is information indicating a thickness in the 3D data, and the determination unit determines the thickness in the 3D data based on the distance information and size of the specific object in an image of each of the plurality of object regions.

10. The 3D data generation apparatus according to claim 7, wherein
the distance information of each image in the 3D data is information indicating a thickness in the 3D data, and the determination unit determines the thickness in the 3D data in accordance with an absolute distance in which the specific object in an image of each of the plurality of object regions exists.

11. The 3D data generation apparatus according to claim 9, wherein
the determination unit determines the thickness in the 3D data to be equal to or smaller than a printable thickness in a printing apparatus that performs printing based on the 3D data.

12. The 3D data generation apparatus according to claim 7, wherein
the determination unit determines vertical and horizontal widths of each image in the 3D data to fall within a printable range in a printing apparatus that performs printing based on the 3D data.

13. A 3D data generation method, comprising:
acquiring a plurality of images and distance information that corresponds to distances in a depth direction to an object in the plurality of images;
determining a layout for presenting the plurality of images as a piece of 3D data; and
combining the plurality of images in accordance with the determined layout, wherein
in the determination, for distance information of each image in the 3D data, the distance information of each of the plurality of images is converted based on a predetermined criterion.

14. A 3D data generation method, comprising:
extracting a plurality of object regions including a specific object from a plurality of images that have distance information corresponding to distances in a depth direction to one or more objects;
determining a layout for presenting, as a piece of 3D data, images of the plurality of object regions extracted; and
combining the images of the plurality of object regions in accordance with the determined layout, wherein
in the determination, for distance information of each image in the 3D data, the distance information of an image of each of the plurality of object regions is converted based on a predetermined criterion.

15. A computer-readable storage medium storing a program for causing a computer to execute a 3D data generation method that comprises:
acquiring a plurality of images and distance information that corresponds to distances in a depth direction to an object in the plurality of images;
determining a layout for presenting the plurality of images as a piece of 3D data; and
combining the plurality of images in accordance with the determined layout, wherein
in the determination, for distance information of each image in the 3D data, the distance information of each of the plurality of images is converted based on a predetermined criterion.

16. A computer-readable storage medium storing a program for causing a computer to execute a 3D data generation method that comprises:
extracting a plurality of object regions including a specific object from a plurality of images that have distance information corresponding to distances in a depth direction to one or more objects;
determining a layout for presenting, as a piece of 3D data, images of the plurality of object regions extracted; and
combining the images of the plurality of object regions in accordance with the determined layout, wherein
in the determination, for distance information of each image in the 3D data, the distance information of an image of each of the plurality of object regions is converted based on a predetermined criterion.
